(19) United States
(12) Patent Application Publication
(10) Pub. No.: US 2026/0138632 A1
(43) Pub. Date: May 21, 2026

(54) METHOD FOR ENHANCING THE DRIVING SAFETY OF AN AT LEAST PARTIALLY AUTOMATED VEHICLE, AND VEHICLE

(71) Applicant: AUDI AG, Ingolstadt (DE)

(72) Inventor: Daniel LOTTES, Ihrlerstein (DE)

(21) Appl. No.: 19/387,378

(22) Filed: Nov. 12, 2025

(30) Foreign Application Priority Data
Nov. 20, 2024 (DE) 10 2024 134 076.2

(51) Int. Cl. B60W 50/14; B60K 35/23; B60K 35/28; B60W 60/00; G06T 11/00; G06V 20/58

(52) U.S. Cl. CPC B60W 50/14; B60K 35/28; G06T 11/10; B60K 35/23; B60K 2360/175; B60K 2360/177; B60W 2050/146; B60W 60/00; B60W 2420/403; G06V 20/58

(57) ABSTRACT

A method for enhancing driving safety of a vehicle with an at least partially automated driving function. The method is performed by a control unit. The method includes generating environmental data of real surroundings of the vehicle generated by way of a camera, performing a hazard analysis related to a current driving situation of the vehicle in the surroundings represented by the environmental data, determining a characteristic value based on the hazard analysis, the characteristic value being suitable for assessing a potential hazardous situation, determining an augmented image content is determined depending based on the characteristic value, and causing a display device to display the augmented image content integrated into the real surroundings, to characterize the potential hazardous situation from a perspective of an observer. Also, a vehicle with an at least partially automated driving function and a control unit configured to carry out such a method is provided.

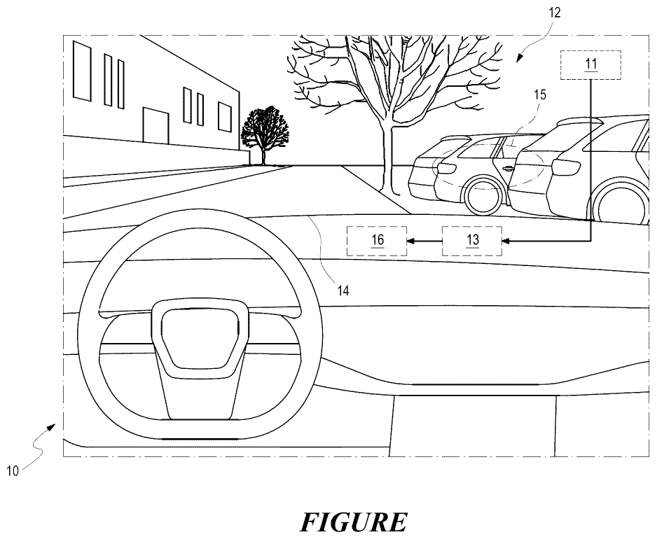

### BACKGROUND

### Technical Field

The disclosure relates to a method for enhancing the driving safety of an at least partially automated vehicle. The disclosure further relates to a vehicle with an at least partially automated driving function.

### Description of the Related Art

Vehicles are known that implement Level 1 (assisted driving), Level 2 (partially automated driving), and Level 3 (highly automated driving) of a total of five levels on the path to fully autonomous vehicles. Vehicles that implement Level 4 (fully automated driving) are in the planning stages. Level 5 refers to autonomous vehicles in which the vehicle occupants are merely passengers without a driving role.

At Level 2, the driver is in constant control of their vehicle and must constantly monitor the traffic. Only some tasks are temporarily performed by the vehicle itself—without human intervention. For example, a Level 2 vehicle is capable of maintaining lane, braking, and accelerating simultaneously on the highway.

Highly automated vehicles (Level 3) can perform certain driving tasks independently and without human intervention, but only for a limited period of time and under suitable conditions specified by the manufacturer. These driving tasks can comprise, for example, overtaking, braking, and accelerating, as required by the traffic situation.

At Level 4, the driver can completely relinquish control of the vehicle and becomes a passenger. The vehicle can travel on certain routes (e.g., highway, parking garage) completely independently. It can then also drive without occupants. Passengers may, for example, sleep, use their smartphones, or read a newspaper. The system recognizes its limits in time to reach a safe state in compliance with the regulations. At the end of a fully automated journey, the occupants may resume control of the vehicle again. However, if they are unable or unwilling to do so, the vehicle must reach a safe state and, for example, head for a parking space.

Also known are so-called “augmented reality head-up displays” (AR-HUDs). These like conventional head-up displays-provide display functions close to the vehicle's windshield (e.g., blackprint displays).

Furthermore, probability models implemented in software are known which can provide an analysis of a hazardous situation while the vehicle is driving.

For example, DE 10 2017 220 268 A1 describes a method for detecting and visualizing system uncertainty when displaying augmented image content in a motor vehicle's head-up display (AR-HUD). The head-up display serves to display contact-analog navigation and warning or hazard information for a driver of the motor vehicle, wherein information is displayed according to their position and orientation in the real world.

DE 10 2009 003 220 A1 discloses a method and a device for collision warning. The method comprises contact-analog marking of an object representing a specific collision risk by way of a head-up display for a driver of a motor vehicle.

### BRIEF SUMMARY

Against this background, an embodiment of the disclosure provides a method that enhances driving safety of an at least partially automated vehicle. Furthermore, an embodiment of the disclosure provides a vehicle with an at least partially automated driving function whose driving safety is enhanced.

It should be noted that a conjunction “and/or” used herein between two features and linking them together is always to be interpreted in such a way that in a first configuration of the embodiments according to the disclosure only the first feature can be present, in a second configuration only the second feature can be present and in a third embodiment both the first and the second feature can be present.

An embodiment of the is disclosure a method for enhancing driving safety of an at least partially automated vehicle. Here, environmental data of real surroundings of the vehicle is generated by way of a camera and transmitted to a control unit. A hazard analysis related to a current driving situation of the vehicle in the surroundings represented by the environmental data is carried out by way of the control unit, which is preferably an electronic control unit having a microprocessor, a microcontroller, a digital signal processor (DSP), or similar. Furthermore, a characteristic value is determined based on the hazard analysis and is suitable for assessing a potentially hazardous situation. Here, the potentially hazardous situation within the meaning of the disclosure does not represent an acute collision situation that would require action by a driver of the vehicle. Rather, the potentially hazardous situation characterizes a situation (also referred to herein as a hotspot) that could only develop into an acute collision situation upon the occurrence of one or more further events. A hotspot is therefore an area in the real surroundings into which the vehicle is expected to enter and in which a hazard to road traffic could potentially occur.

The method further provides that, depending on the determined characteristic value, an augmented image content is determined and displayed, integrated into the real surroundings, by way of a display device to characterize the potentially hazardous situation from the perspective of an observer (e.g., a driver). Such a display device can also be referred to as a head-up display.

Augmented image content (e.g., symbols, information) is understood to mean content in which information is displayed according to its position and orientation in the real surroundings, in order to give the observer of the real surroundings the impression of a natural image. Accordingly, the augmented image content is preferably displayed in proximity of a window, e.g., near a windshield of the vehicle, through which the observer perceives the real surroundings of the vehicle. However, the disclosure is not necessarily limited exclusively to the windshield. For example, the display of augmented image content near a side or rear window of the vehicle is also conceivable.

Partially automated driving corresponds to Level 2 of the five mentioned levels up to autonomous driving (Level 5), as already described at the beginning.

It should be understood that the hazard analysis does not have to be limited exclusively to the environmental data generated by the camera. Other vehicle sensors, such as, for example, radar, lidar, ultrasonic sensors, and the like, can provide additional environmental data that can be considered in the hazard analysis. Furthermore, vehicle data, such as, for example, current speed, acceleration, direction of travel, etc., can be incorporated into the hazard analysis.

The disclosure makes it possible to direct the attention or gaze of the observer, e.g., the driver, to specific traffic situations. Said directing is provided by the displayed augmented image content as a result of the hazard analysis. In this way, the driver of the vehicle is alerted to potential hazards before intervention is necessary. Accordingly, the method according to the disclosure is to be understood merely as an indicative method, not as a method for directing action.

As already described, the driver of the vehicle with a partially automated driving function (i.e., Level 2) must at all times keep their attention and their gaze, respectively, directed to the traffic situation while driving. However, they do not know which event might require takeover, i.e., active intervention. Furthermore, the driver does not know whether the vehicle is even correctly assessing or registering such hazardous situations. The disclosure closes these information gaps. The driver can now pay increased attention to the area of traffic that entails a potential hazardous situation, thereby reliably fulfilling their monitoring task at Level 2, which overall enhances driving safety.

In an advantageous embodiment, the characteristic value assesses the potential hazardous situation on the basis of different urgency levels, each urgency level being assigned a different color in which the augmented image content is displayed by the display device. For example, in a case where there is no particular urgency, i.e., where only normal attention is required from the observer, the augmented image content can be displayed in white, and in a case with a comparatively increased urgency or increased required attention, it can be displayed in a different color, e.g., red. Accordingly, a prioritization that specifically directs attention among several potential hazardous situations can be implemented, further improving driving safety. For example, the prioritization can be based on a distance or travel time until the area of the potential hazardous situation is reached, with the potential hazardous situation that the vehicle will reach next being given higher priority.

Further advantageous embodiments provide that the characteristic value is suitable for assessing multiple potential hazardous situations, wherein an augmented image content is determined for each potential hazardous situation and displayed by way of the display device to characterize the respective hazardous situation. In this way, multiple potential hazardous situations can be simultaneously characterized in the observer's field of vision by different augmented image content, so that the driver is alerted to different potential hazardous situations at an early stage.

Furthermore, embodiments of the disclosure include a vehicle with an at least partially automated driving function, i.e., a driving function which corresponds at least to Level 2 of the five levels described herein up to the fully autonomous driving function. The vehicle has a camera for generating environmental data of real surroundings of the vehicle, furthermore a control unit which is configured to receive the environmental data and to carry out a hazard analysis related to a current driving situation of the vehicle in the surroundings represented by the environmental data, to determine a characteristic value based on the hazard analysis which is suitable for assessing a potential hazardous situation, and to determine an augmented image content depending on the determined characteristic value and to display it, integrated into the real surroundings, by way of a display device to characterize the hazardous situation from the perspective of an observer (e.g., driver).

It should be understood that with regard to vehicle-related definitions of terms as well as the effects and advantages of vehicle-specific features, the disclosure of corresponding definitions, effects, and advantages of the method according to the disclosure can be fully relied upon, and vice versa. Repetition of explanations of similar features, their effects, and advantages can thus be omitted in favor of a more concise description, without such omissions being interpreted as a limitation of any of the disclosed embodiments of the disclosure.

In an advantageous embodiment, the display device is designed as an augmented reality head-up display (AR-HUD). This AR-HUD displays the augmented image content on a vehicle window through which the observer views the real surroundings (e.g., windshield, side window, rear window).

In a further advantageous embodiment, the display device is configured to represent or display the augmented image content on a windshield of the vehicle.

Yet another advantageous embodiment provides that the vehicle has a highly or fully automated driving function, accordingly a driving function of the Levels 3 or 4 described herein. In Levels 3 or 4, the driver may have limited confidence in the driving functions implemented in the vehicle, which is why monitoring the driving situation by the driver may be desired, even though road traffic does not have to be monitored by the driver. The disclosure further increases confidence, as the driver can reliably understand at any time whether the vehicle automatically and reliably detects potentially hazardous situations. In this way, unnecessary, sudden interventions by the driver and, consequently, abrupt and possibly unsafe driving maneuvers by the vehicle can be avoided, thus enhancing the driving safety of the vehicle.

### BRIEF DESCRIPTION OF THE SEVERAL VIEWS OF THE DRAWINGS

Further features and advantages of the disclosure will become apparent from the following description of non-limiting embodiments of the disclosure, which will be explained in more detail below with reference to the drawing. In this drawing, the only

The FIGURE schematically shows part of a vehicle according to an embodiment of the disclosure, in which a method according to an embodiment of the disclosure is implemented.

### DETAILED DESCRIPTION

A vehicle 10 shown in the Figure has an at least partially automated driving function, i.e., a driving function according to Levels 2, 3 or 4 described herein.

The Figure shows that vehicle 10 has at least one camera 11. Said camera 11 serves to generate environmental data of real surroundings 12 of vehicle 10. Furthermore, vehicle 10 has an electronic control unit 13 that is configured to receive the environmental data and to carry out a hazard analysis related to a current driving situation of vehicle 10, as shown by way of example in the Figure viewed through a windshield 14 of vehicle 10, in surroundings 12 represented by the environmental data.

Control unit 13 is further configured to determine a characteristic value based on the hazard analysis, which is suitable for assessing at least one potential hazardous situation. Depending on the determined characteristic value, control unit 13 determines an augmented image content 15, which is shown in the Figure by way of example as an elliptical marking. Other geometric figures, symbols, information, and the like are conceivable. To characterize the potential hazardous situation, the augmented image content is displayed, integrated into real surroundings 12, by way of a display device 16, which can be designed, for example, as an augmented reality head-up display, from the perspective of an observer, e.g., a driver of vehicle 10 (not shown in the Figure), as can be seen in the Figure.

The potentially hazardous situation illustrated in the Figure may, for example, consist of an object or a person, e.g., a child, potentially emerging from between the parked vehicles shown in the Figure at the side of the road. Displayed augmented image content 15 draws the driver's attention to this area early and specifically. This example illustrates that the display of the augmented image content 15 does not involve any specific action or intervention on the part of the driver. It merely draws their attention specifically to the potentially hazardous situation. Furthermore, the driver of vehicle 10 recognizes that the at least partially automated driving function of the vehicle is capable of detecting such a potentially hazardous situation, thereby strengthening the driver's confidence in the reliability of the at least partially automated driving function.

An exemplary embodiment of the method according to the disclosure, which is implemented in vehicle 10 of the FIGURE, i.e., whose control unit 13 is designed to carry out the method according to the disclosure, comprises the following steps:
generating environmental data of real surroundings 12 of vehicle 10 by way of camera 11;
transferring the generated environmental data to control unit 13;
carrying out a hazard analysis related to a current driving situation of vehicle 10 in surroundings 12 represented by the environmental data by control unit 13;
determining a characteristic value based on the hazard analysis, wherein the characteristic value is suitable for assessing a potential hazardous situation;
determining an augmented image content 15 depending on the determined characteristic value; and
displaying augmented image content 15 for characterizing the potential hazardous situation by way of display device 16 (e.g., AR-HUD) from the perspective of an observer (e.g., the driver not shown in the Figure), integrated into real surroundings 12.

German patent application no. 102024134076.2, filed Nov. 20, 2024, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for enhancing driving safety of a vehicle with an at least partially automated driving function, the method comprising:
receiving, by a control unit, environmental data of real surroundings of the vehicle generated by way of a camera;
performing, by the control unit, a hazard analysis related to a current driving situation of the vehicle in the real surroundings represented by the environmental data;
determining, by the control unit, a characteristic value based on the hazard analysis, wherein the characteristic value is suitable for assessing a potential hazardous situation;
determining, by the control unit, an augmented image content based on the characteristic value; and
causing, by the control unit, a display device to display the augmented image content integrated into the real surroundings, wherein the augmented image content integrated into the real surroundings characterizes the potential hazardous situation from a perspective of an observer.

2. The method according to claim 1, wherein the characteristic value assesses the potential hazardous situation based on different urgency levels, and wherein each of the different urgency levels is assigned a different color in which the augmented image content is displayed by the display device.

3. The method according to claim 1, wherein the characteristic value is suitable for assessing multiple potential hazardous situations, and wherein the method further comprises:
determining a plurality of augmented image contents, wherein each of the augmented image contents is determined for one of the potential hazardous situations; and
displaying, by the display device, each of the augmented image contents integrated into the real surroundings, wherein each of the augmented image contents integrated into the real surroundings characterizes one of the potential hazardous situations.

4. A vehicle with an at least partially automated driving function, the vehicle comprising:
a camera that, in operation, generates environmental data of real surroundings of the vehicle; and
a control unit that, in operation:
receives the environmental data;
performs a hazard analysis related to a current driving situation of the vehicle in the real surroundings represented by the environmental data;
determines a characteristic value based on the hazard analysis, wherein the characteristic value is suitable for assessing a potential hazardous situation;
determines an augmented image content based on the characteristic value; and
causes a display device to display the augmented image content integrated into the real surroundings, wherein the augmented image content integrated into the real surroundings characterizes the potential hazardous situation from a perspective of an observer.

5. The vehicle according to claim 4, wherein the display device is an augmented reality head-up display.

6. The vehicle according to claim 4, wherein the display device, in operation, displays the augmented image content on a windshield of the vehicle.

7. The vehicle according to claim 4, wherein the at least partially automated driving function is a fully automated driving function.
